(19) United States
(12) Patent Application Publication
(10) Pub. No.: US 2016/0073249 A1
(43) Pub. Date: Mar. 10, 2016

(54) SYSTEM AND METHOD FOR DISCOVERING A WIRELESS DEVICE

(71) Applicant: QUALCOMM Incorporated, San Diego, CA (US)

(72) Inventors: Adam Moore, San Francisco, CA (US); Johan Le Nerriec, San Francisco, CA (US); Philip Kearney, San Jose, CA (US); Daniel Tai, Union City, CA (US)

(21) Appl. No.: 14/611,021

(22) Filed: Jan. 30, 2015

Related U.S. Application Data
(60) Provisional application No. 62/046,890, filed on Sep. 5, 2014.
(60) Provisional application No. 62/046,886, filed on Sep. 5, 2014.

(51) Int. Cl. H04W 8/00; H04L 29/08; H04W 4/02

(52) U.S. Cl. CPC H04W 8/005; H04W 4/023; H04L 67/1068; H04W 84/12

(57) ABSTRACT

One or more discovery communications are received by a user device over a wireless communication medium. The one or more discovery communications can be communicated using a Layer 2 protocol. The one or more discovery communications can be processed to determine information included with the one or more discovery communications. The information can include an identifier of the wireless device and dynamic information about an active process of the wireless device. When the user device is not connected to the discovered wireless device, the user device displays a representation of the wireless device. The representation can include information determined from the one or more discovery communications, including the identifier of the wireless device and content that is based on the dynamic information.

### RELATED APPLICATIONS

This application claims benefit of priority to Provisional U.S. Patent Application No. 62/046,890, filed Sep. 5, 2014; and to U.S. Patent Application No. 62/046,886, filed Sep. 5, 2014; both of the aforementioned priority applications being hereby incorporated by reference in their respective entirety.

### BACKGROUND

Network connected devices interconnect and communicate using a variety of different protocols. Local area networks, for example, can include devices that wirelessly connect to access points, as well as devices that connect to one another as peers.

### BRIEF DESCRIPTION OF THE DRAWINGS

FIG. 1A illustrates an example system for discovering wireless devices on one or more networks, according to some embodiments.

FIG. 1B illustrates a discovery and connection process for a system such as described with FIG. 1A, according to some embodiments.

FIG. 2A illustrates an example of a wireless device, according to some embodiments.

FIG. 2B illustrates an example of a user device for use on a wireless network, according to some embodiments.

FIG. 3A illustrates an example method for enabling a wireless device to be discovered through use of a wireless peer-to-peer communication medium, according to some embodiments.

FIG. 3B illustrates an example method for discovering a wireless device using a wireless peer-to-peer communication medium, according to some embodiments.

FIG. 3C illustrates an example method for connecting to a discovered wireless device using a wireless peer-to-peer communication medium, according to some embodiments.

FIG. 4 illustrates an example of a user interface to display discovery and connection information about other discovered devices, according to some embodiments.

FIG. 5 illustrates a process for enabling a user device to discover and select from alternative connection mediums for purpose of connecting to a particular device, according to some embodiments.

FIG. 6 illustrates an example method for enabling a user device to discover and select from alternative connection mediums for purpose of connecting to a particular device, according to some embodiments.

FIG. 7 illustrates a method for configuring a non-peer wireless device to implement peer-to-peer wireless communication and discovery, according to an embodiment.

FIG. 8 is a block diagram that illustrates a computer system upon which embodiments described herein may be implemented.

### DETAILED DESCRIPTION

Embodiments described herein provide a wireless device, system and method which enable wireless device discovery that includes both dynamic (e.g., real-time or current state) and static information. The information determined from the discovery process can be displayed on a user device prior to the user device connecting to the discovered device.

In some embodiments, an active process is monitored on the wireless device to obtain state information relating to the active process. Static information about the wireless device is determined. One or more discovery communications (e.g., advertisement) are generated for the wireless device using a wireless communication medium. The one or more discovery communications can include (i) a set of data items that are based on the static information, and (ii) dynamic information that is based on the state information of the active process.

In some embodiments, a system, method and device are provided to enable interaction with a wireless device on a network. One or more discovery communications are received by a user device over a wireless communication medium. The one or more discovery communications can be communicated using a Layer 2 protocol. The one or more discovery communications can be processed to determine information included with the one or more discovery communications. The information can include an identifier of the wireless device and dynamic information about an active process of the wireless device. When the user device is not connected to the discovered wireless device, the user device displays a representation of the wireless device. The representation can include information determined from the one or more discovery communications, including the identifier of the wireless device and content that is based on the dynamic information. In response to user input, the user device connects to the wireless device using a Layer 3 protocol. When connected to the wireless device, the user device updates the representation of the wireless device to include one or more control features for controlling the wireless device using the Layer 3 protocol.

In examples described herein, reference to the Layer 2 and Layer 3 protocols is in reference to the Open System Interconnection (OSI) model.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### System Description

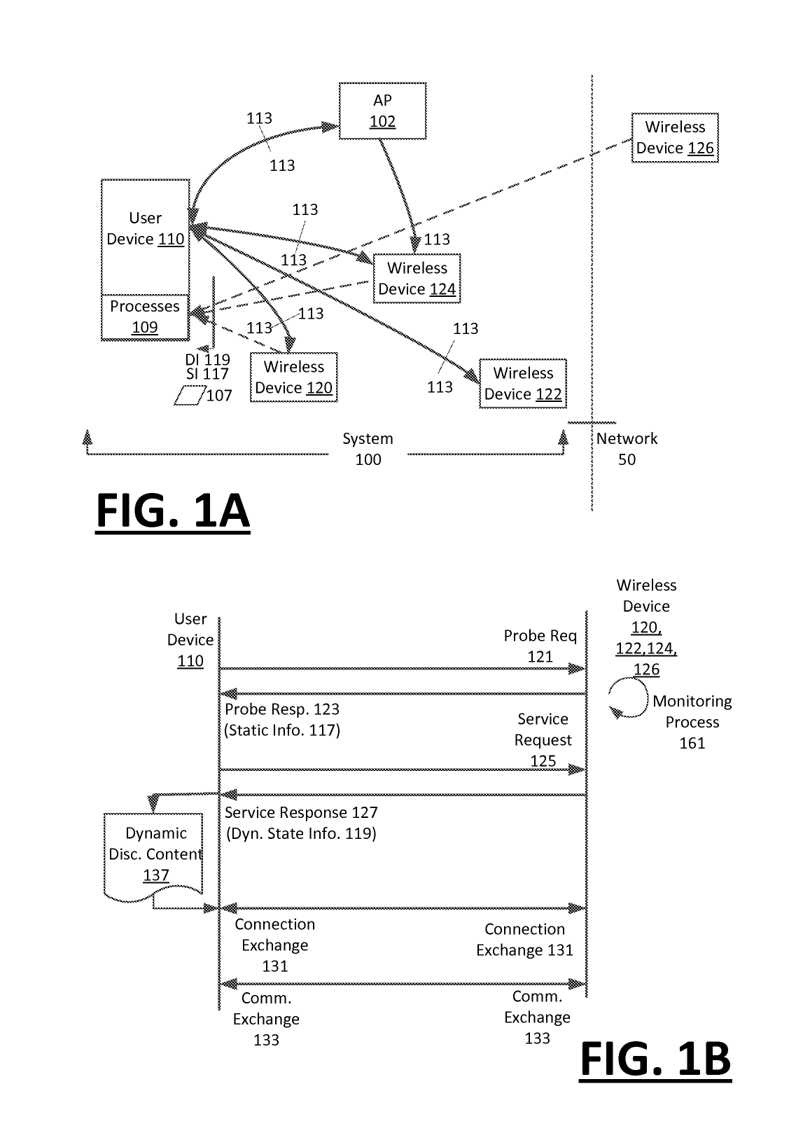

FIG. 1A illustrates an example system for discovering wireless devices on one or more networks, according to an embodiment. In particular, a system 100 can be implemented as part of a local area network (e.g., home network), or as part of a combination of adjacent networks that are in sufficient proximity to enable local wireless connections as between devices. In an example of FIG. 1A, system 100 includes a user device 110 and one or more wireless devices 120, 122, 124. Additionally, one or more wireless devices may be accessible on an adjacent but proximate local wireless network. More specifically, the user device 110 can access and identify, as an example, a wireless device 126 residing outside of a wireless network 50 of the user device, but sufficiently proximate to receive and exchange communications with the user device over a wireless communication medium (e.g., Wi-Fi Direct).

With further reference to FIG. 1A, the user device 110 and wireless devices 120, 122, and 124 are each configured to operate on the local wireless network 50. By way of example, the access point 102 of the wireless network 50 can be implemented under IEEE Specifications of 802.11(a), 802.11(b), 802.11(g), or 802.11(n) (collectively “Wi-Fi” or “Wi-Fi network”). In an example of FIG. 1A, the access point 102 can be connected to each of the user device 110 and/or wireless devices 120, 122, and 124. Additionally, the user device 110 and the individual wireless devices 120, 122, 124 can communicate using a direct, wireless peer-to-peer communication protocol, such as provided by Wi-Fi Direct. The use of a wireless peer-to-peer communication protocol can further enable individual devices on the wireless network 50 (e.g., user device 110) to communicate with devices that are in sufficient proximity for the wireless communication medium (e.g., Wi-Fi Direct), but which reside outside of the wireless network 50 (e.g., wireless device 126).

In one example, the user device 110 corresponds to a mobile computing device (e.g., smartphone are cellular telephony/messaging device, tablet, wearable computing device etc.) capable of (i) wireless connectivity with the access point 102 of the wireless network 50, and (ii) wireless peer-to-peer connectivity with other devices that are in sufficient proximity. In some embodiments, the user device 110 includes system level functionality for implementing wireless discovery and connectivity functions using wireless peer-to-peer connectivity. Alternatively, the user device 110 includes an application or process for implementing wireless discovery and connectivity using wireless peer-to-peer connectivity. By way of example, each of the wireless devices 120, 122, 124, 126 can correspond to a wireless-enabled appliance or dedicated device, such as a wireless speaker, audio/video playback system, lighting system, or home appliance.

In some embodiments, the user device 110 implements a first discovery process in order to identify wireless devices 120, 122, 124, 126 that are accessible over the wireless communication medium for peer-to-peer communications. The user device 110 can implement the first discovery process with each of the wireless devices 120, 122, 124, 126. Each discovery process can be implemented to include the exchange of one or more discovery communications 107 as between the user device 110 and each of the wireless device 120, 122, 124, 126. The discovery communications 107 can include discovery advertisements generated on each of the respective wireless devices 120, 122, 124, 126, and communicated to the user device using a Layer 2 protocol (e.g., Data Link protocol). Among other information, the one or more discovery communications 107 can identify the MAC address and identifier of each wireless device 120, 122, 124 and 126 to the user device 110.

According to some embodiments, the wireless devices 120, 122, 124, 126 are each configured to generate one or more discovery communications 107 that include (i) static information 117, such as a description of the device, a firmware or software version implemented on the device, a system mode implemented on the device, and/or a network connection of the device; and (ii) dynamic (e.g., real-time) state information 119 about active processes that execute on the respective devices. The dynamic state information 119 can reflect a current or real-time state of a process executing on a corresponding one of the wireless devices 120, 122, 124, 126.

Accordingly, as shown with an example of FIG. 1, the static information 117 and the dynamic state information 119 of each wireless device 120, 122, 124, 126 can be communicated to the user device 110 as part of a discovery process, such as shown by an example of FIG. 1B. In this way, the user device 110 can be configured to utilize the discovery communications 107 to (i) determine the MAC address and identifier of the individual wireless devices 120, 122, 124, 126, (ii) identify additional static information 117 about the individual wireless devices 120, 122, 124, 126, and (iii) receive and process the dynamic state information 119 communicated from the individual wireless devices 120, 122, 124, 126.

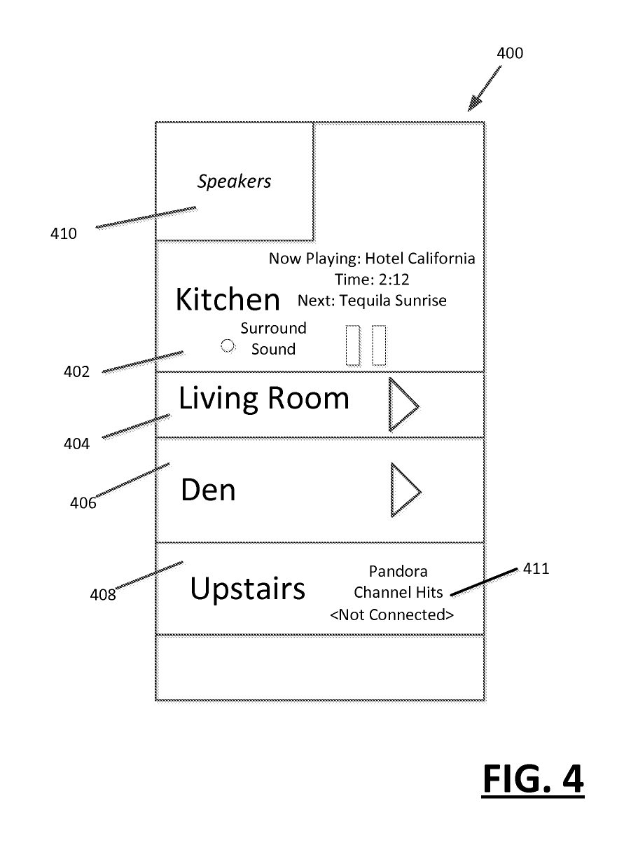

In some embodiments, the user device 110 implements system-level processes 109 to utilize and display content corresponding to the static information 117 and the dynamic state information 119. In variations, applications or other processes that execute on the user device 110 can utilize the static information 117 and dynamic state information 119 communicated by the individual wireless devices 120, 122, 124, 126. The static information 117 and the dynamic state information 119 from a particular wireless device 120, 122, 124, 126 can be rendered on the user device 110 (e.g., via a user interface 400 of FIG. 4) without the user device 110 connecting to that particular wireless device.

According to some embodiments, the user device 110 can be operated to connect to individual wireless devices 120, 122, 124, 126 at the selection of, for example, a user. The connection can be accomplished using a Layer 2 protocol. Once the Layer 2 connection is made, a discovery and connection exchange 113 can be performed using a Layer 3 protocol (e.g., “Internet Protocol”). The Layer 3 protocol can correspond to a communication protocol that enables the user device 110 to receive an IP address of another device. The discovery and connection exchange 113 can be implemented by the user device 110 issuing, for example, a multicast communication to the wireless devices 120, 122, 124 and 126. The responses to the multicast communication from the individual wireless devices 120, 122, 124 and 126 can include an IP address of the respective wireless device, as well as information identifying the capability and services available from the responding wireless device 120, 122, 124 and 126. The user device 110 can automatically connect to the select wireless devices 120, 122, 124 and 126 upon performing the discovery and connection exchange 113 using the Layer 3 protocol. As a result of the discovery and connection exchange 113, the user device 110 can make a connection to one of the wireless devices 120, 122, 124, 126 that is direct (e.g., using Wi-Fi Direct), or peer-to-peer, rather than implemented through the access point 102. Additionally, once the Layer 3 connection is made, the user device 110 can process input to control aspects of the wireless device 120, 122, 124, 126. In this way, the user can view Layer 2 information (including dynamic state information 119) in order to select which of the wireless devices 120, 122, 124 and 126 that the user device 110 will connect to over Layer 3.

FIG. 1B illustrates a discovery and connection process for a system such as described with FIG. 1A, according to some embodiments. In particular, an example of FIG. 1B illustrates a discovery and connection process that can be implemented to establish a direct, peer-to-peer wireless connection between devices (e.g., user device 110 and wireless device 120), over a local wireless communication medium (e.g., Wi-Fi Direct). Accordingly, a discovery and connection process of an example of FIG. 1B can be implemented in part using the discovery communications 107 that are exchanged between the user device 110 and any of the wireless devices 120, 122, 124 and 126. Additionally, in some embodiments, the discovery communications can be communicated using a Layer 2 protocol, and result in the user device 110 receiving and displaying content and information that is based on dynamic state information 119 and static information 117 determined from one or more of the wireless devices 120, 122, 124, 126 which are discovered as being available for a wireless peer-to-peer connection. The user device 110 can make a subsequent connection with any one of the discovered devices using a Layer 3 protocol discovery and connection process.

With reference to FIG. 1B, the user device 110 can initiate a Layer 2 discovery process by communicating one or more probe request 121 to each of the wireless devices 120, 122, 124, 126 that are within proximity of the communication medium (e.g., using Wi-Fi Direct). The wireless devices 120, 122, 124, 126 can each provide a discovery communication 107 that is a probe response 123 to the probe request 121. The probe response 123 can include the static information 117, which can include information that identifies the MAC address and identifier of the responding wireless device 120, 122, 124, 126. Additionally, the responding wireless device 120, 122, 124, and 126 can include additional static information 117 such as the description of the responding device, a firmware or software version implemented on the responding wireless device, a system mode implemented on the wireless device, and/or a network connection of the responding wireless device.

Following the probe responses 123, the user device 110 can signal one or multiple (e.g., series) of service requests 125 and receive one or more discovery communications 107 that include service responses 127 from responding wireless device 120, 122, 124, 126. The service responses 127 can also be communicated using the Layer 2 protocol. As detailed below, the service responses 127 provide the user device 110 with static information 117 and/or dynamic state information 119 from the wireless device of the respective response.

In more detail, each of the wireless devices 120, 122, 124, 126 can be configured to run a programmatic monitor for an active process (“monitoring process 161”) that is executing on that device. The monitoring process 161 can generate the dynamic state information 119, which can identify an operational or execution state of the wireless device 120, 122, 124, 126. For example, in the case of a wireless speaker, the dynamic state information 119 can include information about a media playback process, including information which (i) identifies a media resource that is being played back through that speaker, including a location in the media resource where the current point of playback is at, (ii) nnetadata content, such as album art, artist, title, etc., and/or (iii) information about a next event, such as a next song that is to be played back (e.g., based on a pre-existing playlist). In another example, the wireless devices 120, 122, 124, 126 can include lights for a home lighting system, and the dynamic state information 119 can indicate a power state (e.g., luminosity level) of the light and/or a current color or hue of the individual lights.

In some embodiments, the user device 110 is configured to operate in a discovery mode, which results in continuous or repeated generation of service requests 125 to the available or discovered wireless device 120, 122, 124, 126. In turn, the wireless devices 120, 122, 124, 126 provide service responses 127 which update the dynamic state information 119 of the respective wireless device. The user device 110 can also be configured to implement functionality, such as a user interface, to display the dynamic state information 119 provided with the individual service responses 127. For example, the user device 110 can display graphic representations of each discovered wireless device 120, 122, 124 and 126. For devices that are in active use, the graphic representations can include dynamic discovery content 137 that is based on the dynamic state information 119 received from that device. The dynamic state information 119 can be indicative of a state of the active process executing on the responding wireless device.

In some embodiments, the user has the ability to select to connect with wireless devices that are identified through the discovery process. For example, the user can interact with the user device 110 based on the graphic representations of one or more of the wireless devices 120, 122, 124 and 126. The information contained in the service responses 127 of a particular one of the wireless devices 120, 122, 124 and 126 can be rendered as content on the user device 110, enabling the user to signal selection input for connecting to the device.

In response to the user selection input, the user device 110 can initiate a sequence of communications, shown as connection exchange 131, to connect to the selected wireless devices 120, 122, 124 and 126. The connection exchange 131 can result in the user device 110 and the selected wireless devices 120, 122, 124 and 126 establishing a connection under a Layer 2 protocol.

Once the Layer 2 connection is established, a Layer 3 discovery communication exchange 133 can be initiated which identifies the connected wireless devices 120, 122, 124, 126 and the capabilities or resources of the connected wireless device. This communication exchange 133 under the Layer 3 protocol can result in a connection between the user device 110 and the connected wireless device 120, 122, 124, 126. Once the Layer 3 protocol is established, the user device 110 can, for example, implement functionality to control the connected wireless device 120, 122, 124, 126.

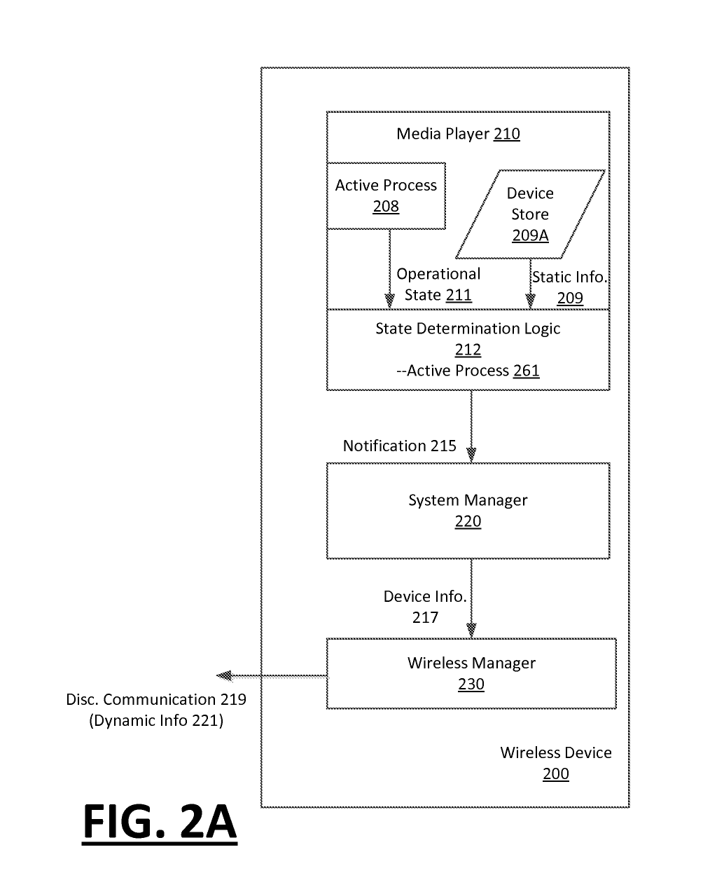

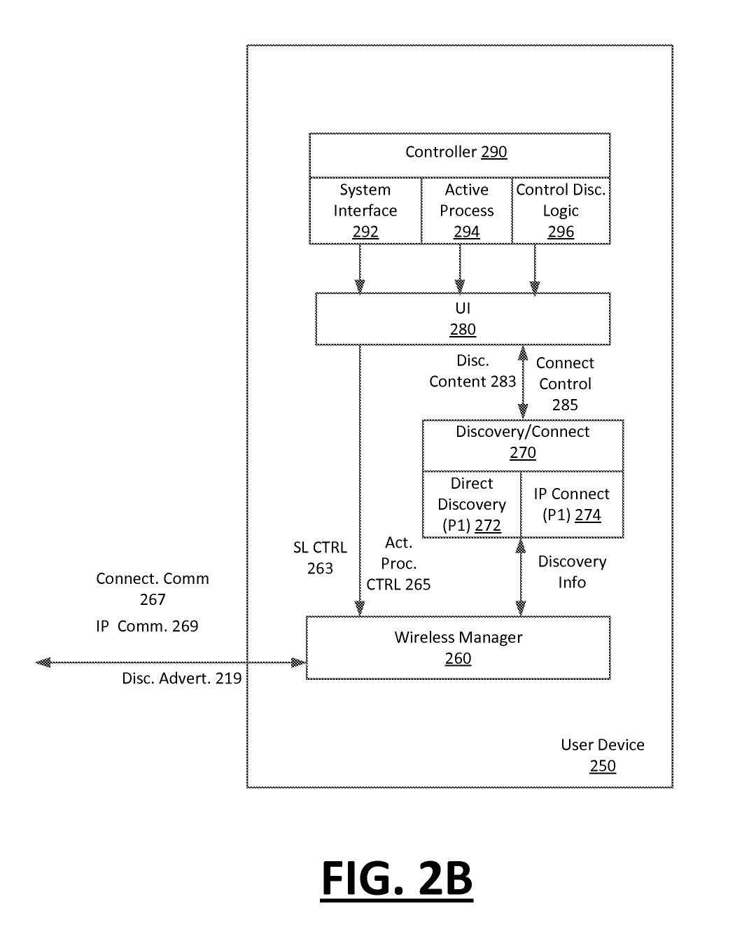

FIG. 2A illustrates an example of a wireless device, according to various embodiments. By way of example, the wireless device 200 can include a network-connected audio output device, such as a wireless speaker or other dedicated device that outputs music. Another non-limiting example of wireless device 200 includes a multifunctional device, such as a mobile device or tablet, which can output video, capture and store audio content, enable user interaction and/or perform numerous other actions. The wireless device 200 can be subjected to a discovery process by, for example, a user device 110 using a peer-to-peer wireless communication medium such as Wi-Fi Direct. While some examples of FIG. 2A are specific to wireless speakers, other embodiments may incorporate different types of wireless devices, such as wirelessly enabled media players, appliances, and dedicated devices (e.g., lights, thermostat, household controllers, etc.).

With reference to FIGS. 1A, 1B and 2A, the wireless device 200 can include a media player 210, a system manager 220, and a wireless manager 230. The media player 210 can include an active process 208, such as an application or routine that provides some output functionality (e.g., music playback). Additionally, the media player 210 can include a state determination logic 212 for the active process 208. The state determination logic 212 can implement one or more monitoring processes 261 to detect an operational state 211 for the active process 208. In the context of a wireless speaker, the monitoring processes 261 can, for example, determine the operational state 211 for the active process 208, including the current title of a song that is being played back, the amount of time that is remaining or which has passed in the song, and/or a next song that is scheduled to be played on the wireless speaker.

The state determination logic 212 can also obtain static information 209 for the wireless device 200 from a device store 209A. The static information 209 can include an identifier of the wireless device 200, such as the SSID of the device. In variations and by way of example, the static information 209 can include one or more of a description of the wireless device 200, a firmware or software version implemented on the wireless device 200, a system mode implemented on the wireless device 200, and/or a network connection of the wireless device 200.

In some variations, the media player 210 communicates the static information 209 and the operational state 211 to the system manager 220. The media player 210 can communicate the static information 209 and operational state 211 by sending an inter-process message notification 215 to the system manager 220. The media player 210 can repeatedly generate such message notifications 215 for the system manager 220, based on operational state 211 detected from the active process 208.

The system manager 220 can receive the notification messages 215 in order to generate device information 217 for communication during a wireless discovery process. The device information 217 can include or be based in part on the static information 209, including data items determined from device store 209A, as well as dynamic state information 221 as determined from the operational state 211. The system manager 220 can determine device information 217 by filtering and/or reformatting the information contained in the notification messages 215. Furthermore, the device information 217 can be repeatedly or continuously updated with the arrival of additional notification messages 215.

The wireless manager 230 can communicate one or more discovery communications 219 to other wireless devices (e.g., user device 110 of FIG. 1A and FIG. 1B) as part of a discovery process. For example, the wireless manager 230 can generate the discovery communication 219 to communicate to user device 110 as part of one or more discovery communications 107 (see FIG. 1A) of a Layer 2 discovery process. In the Layer 2 discovery, for example, the wireless device 200 can generate an initial probe response 123 (FIG. 1B) that includes the MAC address and identifier of the wireless device 200. After the probe response 123 (FIG. 1B), the wireless device 200 can respond to the service request 125 by providing the discovery communication 219 as the service response 127. The discovery communication 219 can include (i) dynamic status information 221, as determined from the operational state 211 of the active process 208 and (ii) static information 209, such as determined from the static information 209.

FIG. 2B illustrates an example of a wireless user device, according to some embodiments. The wireless user device 250 can implement one or more processes to discover other wireless devices 120, 122, 124, 126, 200 that are on a common wireless network or accessible through a wireless communication medium. Additionally, the user device 250 can selectively connect to and interact with the wireless devices 122, 124, 126, 200 that are identified in the discovery processes.

With reference to FIGS. 1A, 1B, 2A and 2B, the user device 250 includes a wireless manager 260, a discovery and connect component 270, a user interface 280 and a controller 290. The discovery and connect component 270 can execute processes to discover and connect wireless resources over the wireless communication medium. In some embodiments, a direct discovery process 272 can be used to discover wireless devices using a peer-to-peer connection. The direct discovery process 272 can implement an initial discovery process using a Layer 2 protocol. As described with examples of FIGS. 1A, 1B, 2A, the direct discovery process 272 can identify (i) the MAC address and identifier of a discovered device, (ii) static information about the discovered device, and/or (iii) dynamic status information about one or more active processes of the discovered device (collectively “discovered information 283”). The discovered information 283 can be rendered in the form of content through the user interface 280. By way of example, the discovered information 283 can display a discovered device along with information that identifies one or more of (i) a user provided name, (ii) a device type, (iii) software, firmware or hardware components, and/or (iv) current state information about an active process on the discovered device. In the context of the wireless device 200, on which media player 210 operates, the current state information can include, for example, the song or track is being played by the media player 210, the name of the artist, the next song that is to be played, an amount of time remaining in the song, album art provided with the song, user rating, and/or information that tracks a current position of the song during the playback on wireless device 200 200.

The controller 290 can include logic for implementing control features through the user interface 280. The controller 290 can implement features for controlling some of the interactions of the user device 250 with other discovered wireless devices. In some embodiments, controller 290 includes control discovery logic 296 that enables the user to provide input with respect to the representation of a discovered but unconnected device (e.g., wireless device discovered through direct discovery process 272). The input can result in connect control 285 triggering the discovery and connect component 270 to establish a connection with the identified wireless device.

According to some embodiments, the discovery and connect component 270 is triggered in response to user input provided through the user interface 280. The discovery and connect component 270 exchanges (via the wireless manager 260) a series of connect communications 267 with the selected wireless device under the Layer 2 protocol to establish the connection. Once the connection is established, the discovery and connect component 270 can initiate an Internet Protocol (“IP”) discover and connect process 274 in which a series of IP communications 269 are exchanged to establish the Layer 3 connection with the selected wireless device.

In some embodiments, the user interface 280 operates to display representations of (i) devices discovered using the direct discovery process 272, prior to a connection being formed to those devices, and (ii) devices that are connected to the user device 250 over either an access point or peer-to-peer connection. More specifically, the representations can include (i) identification of devices that are discovered through a Layer 2 protocol, (ii) static and dynamic information provided with the representations of the devices discovered through the Layer 2 protocol, (iii) identification of devices that are connected to the user device 250 through a Layer 3 protocol, and/or (iv) static and dynamic information provided with the representations of the devices discovered through the Layer 3 protocol. In this way, the user interface 280 displays representations of devices that are discovered or connected though different network layer protocols.

Once the Layer 3 connection is made, the controller 290 can enable the user to control aspects of the selected wireless device 120, 122, 124, 126, 200. In particular, the controller 290 can include system interface logic 292 for enabling system-level control interaction with the selected wireless device 120, 122, 124, 126, 200 through input provided onto the user device 250. For example, the system manager 220 of the wireless device 200 can include a framework for providing an interface that enables programmatic access and communications with the processes of the system manager 220. By way of example, the framework can be provided through ALLJOYN, as hosted by ALLSEEN ALLIANCE. The system-level control input 263 can be communicated to the wireless device (via wireless manager 260) using the Layer 3 connection. In an example of FIG. 2A, the system manager 220 can include a programmatic interface to process instructions communicated by IP communications 269 that correspond to control input 263. The control input 263 can, for example, enable control of the device as a whole, such as enabling the user to after the name of the wireless device, or input or change device settings.

The controller 290 can also include active process logic 294 for enabling control of an active process on the wireless device 120, 122, 124, 126, 200 (e.g., active process 208 of the media player 210 in FIG. 2A). The active process control input 265 can also be communicated to the selected wireless device (via wireless manager 260) using IP communications 269.

With further reference to FIG. 2A, the media player 210 of wireless device 200 can include a programmatic interface that can process instructions communicated by wireless manager 260 (as IP communications 269), corresponding to control input 265. For example, the media player 210 can be configured with a framework to enable programmatic access and interface with the operations of the media player 210. By way of example, the framework can be provided through ALLJOYN, as hosted by ALLSEEN ALLIANCE. The control input 265 can, for example, cause the active process 208 of the media player 210 to pause, skip, fast-forward, increase or decrease volume, alternate selection, etc. The functionality provided through the control input 265 and user interface 280 can be selected as a design parameter for the user device 250.

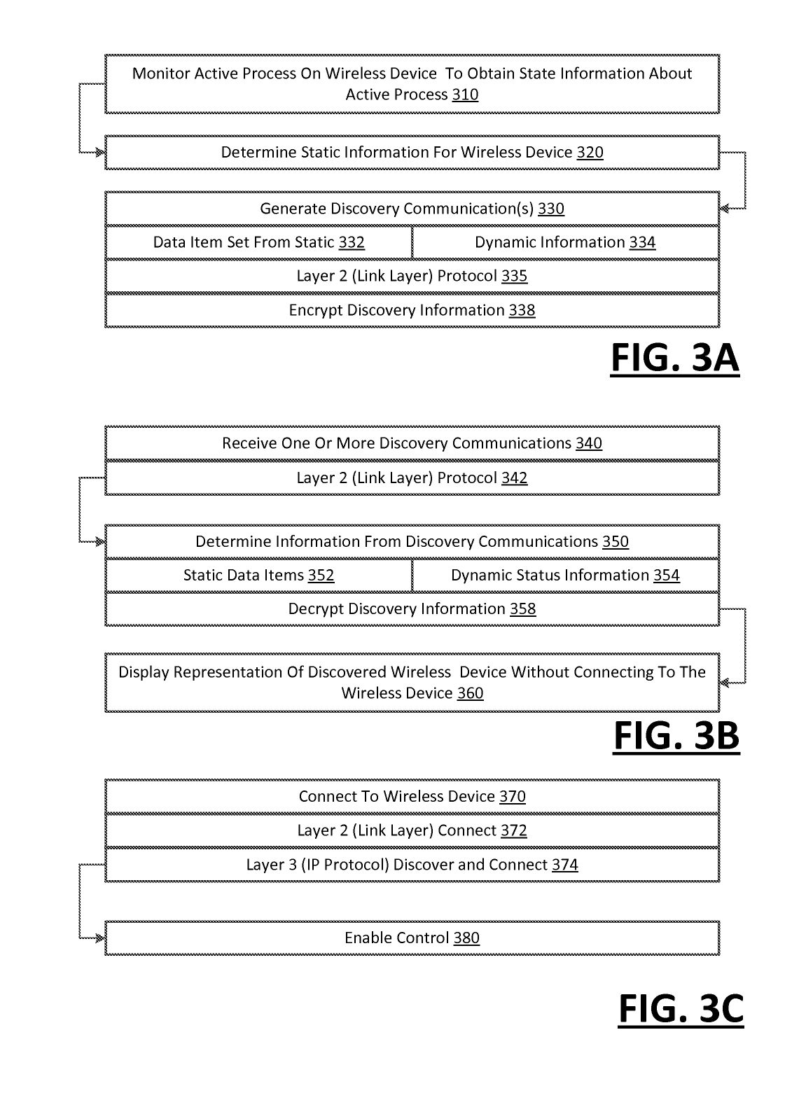

FIG. 3A illustrates an example method for enabling a device to be discovered through use of a wireless peer-to-peer communication medium, according to some embodiments. FIG. 3B illustrates an example method for discovering a device using a wireless peer-to-peer communication medium, according to some embodiments. FIG. 3C illustrates an example method for connecting to a discovered device using a wireless peer-to-peer communication medium, according to some embodiments. In describing examples of FIGS. 3A-3C, reference may be made to examples of FIGS. 1A, 1B, 2A and 2B for purpose of illustrating a suitable component or element for performing a step or sub-step being described.

With reference to FIGS. 1A, 1B, 2A, 2B and 3A, the wireless device 120, 122, 124, 126, 200 monitors one or more active processes 261 on the wireless device to obtain dynamic state information about the active process (310). For example, wireless device 200 can execute the active monitoring process 261 in order to obtain the operational state 211 of the active process 208 of the media player 210. In an example of wireless device 200, the active process 208 can include a playback component. In other embodiments, for example, the active process 208 can include a process that controls an output of a dedicated device (e.g., lighting system, appliance such as refrigerator, Internet enabled thermostat, etc.). The information determined from monitoring the active process can include state information, including dynamic information that changes as a result of the active process performing operations and/or consuming programmatic resources (e.g., music file).

The wireless device 120, 122, 124, 126, 200 determines discovery information for use with discovery communications. The discovery information can include static information for the wireless device (320). For example, the active monitoring process 261 can determine the operational state 211 of the active process. The wireless device 120, 122, 124, 126, 200 can also include a device store 209A for maintaining static information 209 about the wireless device 120, 122, 124, 126, 200. As examples, the static information 209 can include a description of the wireless device 200, a firmware or software version implemented on the wireless device 200, a system mode implemented on the wireless device 200, and/or a network connection of the wireless device 200.

The wireless device 120, 122, 124, 126, 200 can generate one or more discovery communications 219 (e.g., a discovery advertisement) that include the determined information (330). In particular, the discovery communications 219 can include data items determined from the static information 209 (332), as well dynamic state information 221 determined from monitoring active processes on that wireless device 120, 122, 124, 126, 200 (334).

The discovery communications 219 can be provided under a Layer 2 (or Data Link Layer) protocol (335). For example, the wireless device 120, 122, 124, 126, 200 may initially provide a probe response 123 (see FIG. 1B) that includes the MAC address and identifier of the wireless device. Subsequently, the wireless device 120, 122, 124, 126, 200 can provide a service response 127 (see FIG. 1B) that includes the static information 209 and dynamic status information 221 of the wireless device 200.

Still further, in some embodiments, the discovery communications 219 can be encrypted (338). For example, the wireless device 120, 122, 124, 126, 200 can include an encryption component that encrypts some or all of the static information 209 and dynamic status information 221, thereby precluding such information to be viewable to an unknown device that scans the corresponding region. The encryption can be performed using a public encryption key that is shared with the user device, so that the user device is able to receive and use (e.g., display) the information of the discovery advertisement.

With reference to FIGS. 1A, 1B, 2A, 2B and 3B, the user device 110 can receiving one or more discovery communications over a wireless communication medium (340). In some variations, the user device 110 can initiate a discovery process using a wireless peer-to-peer communication medium in order to receive the discovery communications, such as service responses 123, 127. The discovery process can be implemented under a Layer 2 (or Data Link Layer) protocol (342).

The user device 110 can use service responses 123, 127 from the identified wireless device to determine information about the discovered device (350). By way of example, the user device 110 can use an internal Wi-Fi module to scan for the wireless devices 120, 122, 124, 126, 200 that are available. The scan can generate probe requests 121 for identified devices, and the identified wireless devices 120, 122, 124, 126, 200 can then provide the probe response 123. Under the Layer 2 (or Data Link Layer) protocol, the probe response 123 provides the MAC address and identifier of each identified wireless device 120, 122, 124, 126, 200. Once the probe response 123 is received from an identified wireless device 120, 122, 124, 126, 200 the user device 110 can issue a service request 125 and receive the service response 127. The service response 127 can include additional information about the identified wireless device, including static information 209 (352) and/or dynamic status information 221 (354) provided from the discovered wireless device 120, 122, 124, 126, 200.

In some embodiments, the discovery information communicated from the wireless device 120, 122, 124, 126, 200 is encrypted, and the user device includes a decryption key to decrypt the information (358). For example, the user device may utilize a public key that is shared with the discovered device in order to decrypt the discovered information.

Still further, in some embodiments, the user device 110, 250 can display content that is based on the information determined from the discovery process. In some variations, the user device 110 can display a representation of the discovered wireless device without connecting to that device (360). In some examples, the content can include dynamic status information 221, corresponding to an operational state 211 of an active process on the discovered wireless device 120, 122, 124, 126, 200. Additionally, the content can also include static information that includes, for example, a user provided name of the wireless device, a type of the wireless device, a version of the device and/or a description of the wireless device. In this way, the discovery process can be used to display active real-time information about other devices on the wireless network 50, without the user device connecting to the discovered device.

FIGS. 1A, 1B, 2A, 2B, 3B, and 3C, the user device 110, 250 can be operated to connect to a discovered wireless device 120, 122, 124, 126, 200 (370). The user device 110, 250 can be triggered, by for example, user input to establish the connection with the discovered wireless device 120, 122, 124, 126, 200. To establish the connection, the user device 110, 250 can first connect to the discovered device using, for example, a Layer 2 protocol (372). When the Layer 2 connection is made, the user device 110, 250 can implement a Layer 3 discovery and connection process that automatically forms the Layer 3 connection with the discovered wireless device 120, 122, 124, 126, 200 (374). In establishing the Layer 3 connection, the user device 110. 250 can obtain additional information about a discovered device, such as information about the capabilities and resources of the discovered wireless device 120, 122, 124, 126, 200.

Additionally, the use of the Layer 3 protocol enables the user device to implement additional functionality in its communications with the discovered wireless device 120, 122, 124, 126, 200. In particular, the user device 110, 250 can enable control features to control various aspects of the connected wireless device 120, 122, 124, 126, 200 (380). As described, the control features can control, for example, system-level operations of the connected device, as well as operations of an active process on that wireless device.

FIG. 4 illustrates an example of a user interface that displays discovery and connection information about other devices, according to one or more embodiments. A user interface 400 of FIG. 4 can be implemented with, for example, user device 110, 250 of an example of FIG. 2B. Still further, in an example shown, user interface 400 displays information determined from performing discovery and connection processes in a wireless communication medium (e.g., home dwelling etc.) for wireless devices (e.g., wireless speakers) such as described with FIG. 2A.

With reference to FIGS. 1A, 1B, 2A, 2B and 4, the user interface 400 can provide multiple tabs from which different types of wireless devices 120, 122, 124, 126, 200 and services can be selected. Each tab can, for example, display information about a class or group of wireless devices or services which are available to the user device 110. 250.

In an example of FIG. 4, speaker tab 410 displays known wireless devices 120, 122, 124, 200 connected on the wireless network 50, and/or other wireless devices 126, 200 that are available over the wireless communication medium of the user device. In an example of FIG. 4, the user interface includes entries 402 (kitchen speaker), 404 (living room), 406 (den) and 408 (upstairs), each of which correspond to a wireless speaker (or other device) that is accessible to the user device 110, 250. More generally, the user interface 400 displays information about known devices that are either within a given wireless network 50 of the user device 110, 250, or alternatively, devices that are proximate and accessible to the user device 110, 250, over a wireless communication medium. In FIG. 4, the kitchen speaker, living room speaker, and den speaker are connected to the user device 110, 250 on which the user interface 400 is displayed. These connections establish a Layer 3 (or IP) communication channel, where, for example, services of the displayed devices are available and updated on the user interface 280. Each of the connections can be made through either the wireless access point 102 or by way of a wireless peer-to-peer connection (e.g., Wi-Fi Direct). When connected, the speakers can include various kinds of information, including dynamic information (e.g., title tracking played, time remaining). The connection through the Layer 3 link also enables inclusion of control features, such as pause control. Still further, the connection enables capabilities of the particular wireless device 120, 122, 124, 126, 200 to be determined and displayed on the user interface 400. For example, the kitchen speaker can be identified as having Surround Sound functionality. Likewise, connections with the living room and den speakers can enable control functionality for those speakers as well (e.g., play control).

The entry 408 corresponding to the upstairs speakers represents a wireless device that is discovered, but not connected to the user device 110, 250. In particular, the discovery process for the wireless device 120, 122, 124, 126, 200 enables dynamic status information 411 to be displayed with the representation of the discovered device. In order to connect to the device, the user can interact with the user interface 400 by, for example, selecting the entry 408 (or feature provided with the entry). Upon selection, the connection to the corresponding wireless device 120, 122, 124, 126, 200 can be made. For example, as described above, the connection using the Layer 2 protocol can be made, and the discovery and connection processes of the Layer 3 protocol can be completed. Once the connection is made to the device of entry 408, additional information (e.g., information about the capabilities of the upstairs speaker) and functionality (e.g., control functionality) can be included and made active with the rendering of the entry 408 on the user interface 400.

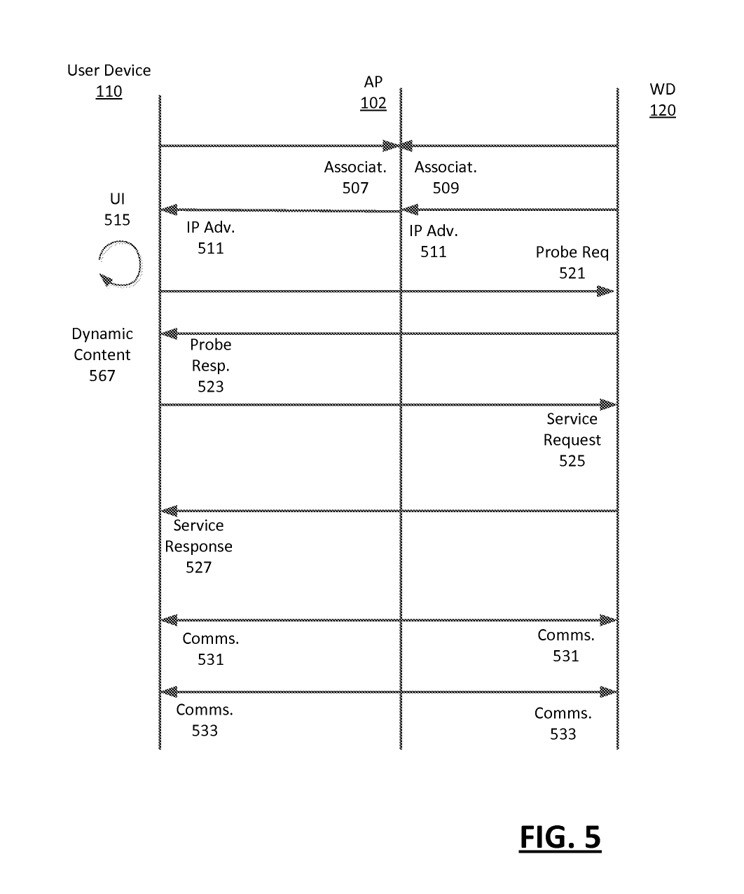

FIG. 5 illustrates a process for enabling a user device to discover and select from alternative connection mediums for purpose of connecting to a particular device, according to some embodiments. A process illustrated by FIG. 5 can be implemented as between, for example, user device 110, 250 and one or more wireless devices 120, 122, 124, 126, 200.

With reference to FIGS. 1A, 2A, 2B and 5, the user device 110, 250 and the wireless device 120, 122, 124, 126, 200 each respectively associate 507, 509 with the access point 102. Accordingly, user device 110, 250 and the wireless device 120, 122, 124, 126, 200 are able to communicate with other devices on the wireless network 50 via the access point 102. Additionally, the user device 110, 250 and the wireless device 120, 122, 124, 126, 200 can discover newly connected devices, as well as obtain information about the capabilities and status of devices that connect to the wireless network 50. When connected to the access point 102, the user device 110, 250 is able to obtain advertisements communicated from other wireless devices 120, 122, 124, 126, 200, including the wireless device 120, using the Layer 3 protocol. Such advertisement 511 can be communicated from the wireless device 120, 122, 124, 126, 200 to the user device 110, 250 via the access point 102. In some embodiments, the user device 110, 250 executes a user interface 515 that receives the IP advertisement 511, and displays content 565 based on information provided with the IP advertisement 511. An example of such content is shown with user interface 400 of FIG. 4.

Some embodiments recognize instances when use of the access point 102 can be less optimal than a direct peer-to-peer wireless connection with the same device. For example, if the user device 110, 250 is to be operated to receive a large amount of data from the wireless device 120, 122, 124, 126, 200, the amount of data that would be channeled through the access point 102 can be a factor in the selection, particularly when the added data would cause congestion that would affect network performance of other devices on the wireless network 50.

In some embodiments, the user device 110, 250 can perform a scan for other devices that are in proximity and which are available for access by way of a wireless peer-to-peer connection. The scan can include sending a probe request 521 to the wireless device 120, and receiving the probe response 523 from the wireless device. The probe response 523 can provide the MAC address and identifier of the wireless device 120, 122, 124, 126, 200. The user device 110, 250 can then issue a service request 525 in order to receive the service response 527. As described with some other embodiments, the service response 527 can include various kinds of information about the responding wireless device 120, 122, 124, 126, 200, including static information 209 (e.g., descriptive information for viewing by the user) and dynamic status information 221 regarding the operational state 211 of the wireless device 200 or the active processes running on the wireless device. The user device 110 can display dynamic content 567 that is based on the discovery information (including the dynamic status information). The dynamic content 567 can display the wireless peer-to-peer discovery information of the wireless device 120, 122, 124, 126, 200 separately from the Layer 3 connection formed via the access point 102. For example, if the wireless device 120, 122, 124, 126, 200 corresponds to a wireless speaker, the user device 110, 250 can display two representations of the same speaker. A first representation can display the speaker as a connected device accessible to the access point 102. A second representation on the user interface 400 (see FIG. 4) can display the speaker as an available device through use of a wireless peer-to-peer connection.

A decision can be made as to whether the user device 110, 250 is to maintain a connection with the wireless device 120, 122, 124, 126, 200 through the access point 102. The decision can be made by way of programmatic logic (e.g., based on measured parameters of the network), and/or by user input (e.g., made through interaction with the user interface 515).

In an example of FIG. 5, the user device 110, 250 connects to the wireless device 120, 122, 124, 126, 200 via the wireless peer-to-peer connection. Accordingly, a series of communications 531 are exchanged between the user device 110, 250 and the wireless device 120 in order to establish a Layer 2 (or Data Link) connection between the two devices. Once the Layer 2 connection is made, a series of communications 533 in accordance with a discovery and connection process can be implemented to establish the wireless peer-to-peer connection as a Layer 3 connection.

According to some embodiments, the wireless peer-to-peer connection as between the user device 110, 250 and one specific wireless device 120, 200 can be maintained concurrently with the connection between the user device 110, 250 and the same wireless device 120, 200 via the access point 102. Content that characterizes both connections can be displayed separately on the user interface 515. For example, the user can switch form one connection to the other, based on preference or programming logic.

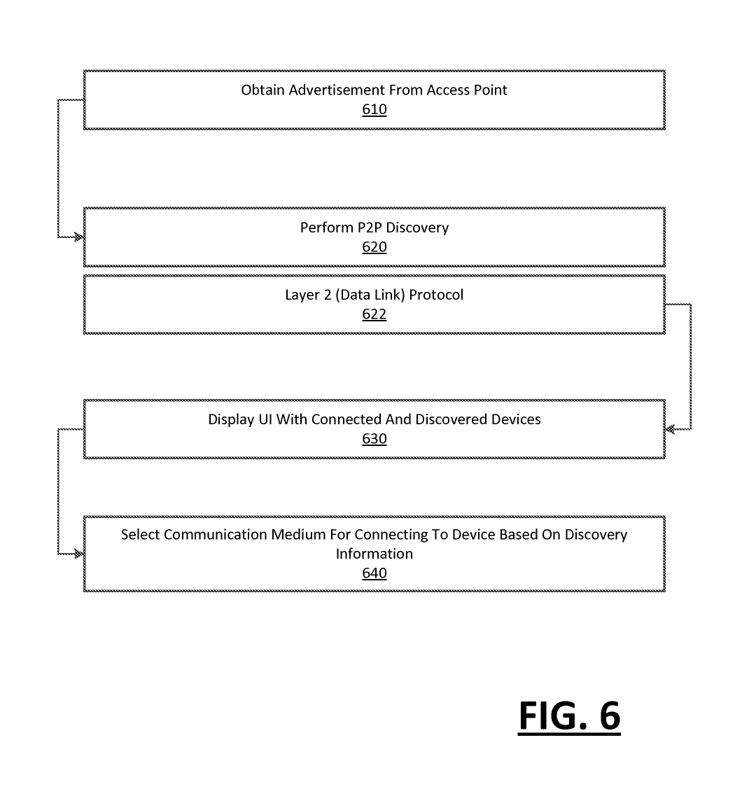

FIG. 6 illustrates an example method for enabling a user device to discover and select from alternative connection mediums for purpose of connecting to a particular device, according to some embodiments. In describing an example of FIG. 6, reference may be made to elements of FIG. 1A, 2A, 2B and FIG. 5 for purpose of illustrating suitable components for performing a step or sub-step being described.

With reference to FIGS. 1A, 2A, 2B, 4 and 6, a device discovery advertisement (e.g., from the wireless device 120) is obtained from an access point 102 (610). The discovery advertisement can be communicated via the access point 102 after both the user device 110, 250 and one of the wireless devices 120, 200 is associated with the access point.

While the wireless device 120, 200 is available through the access point, the user device 110, 250 can operate to discover the same or different devices for implementing wireless peer-to-peer connections (620). The user device 110, 250 can be used to perform a scan, resulting in the discovery of, for example, a wireless device 120, 200. The discovery of the wireless device 120, 200 can be performed via a Layer 2 protocol (e.g., Data Link protocol) (622). As described with some other examples, the discovery information can include dynamic status information, as well as static information that is descriptive of the wireless device 120, 200 or aspects thereof

The user device 110, 250 can provide the user interface 400 that displays both connected devices and those devices which are discovered but not connected (620). With the connected and discovered devices displayed on the user interface 400, a user can identify a particular wireless device 120, 200 and select the communication medium for connecting to the device (630). In some cases, the wireless device 120, 200 connected to the access point 102 can separately be discovered by the user device 110, 250 for a wireless peer-to-peer connection. For example, if the device is already connected to the access point 102, the user can alternatively establish a wireless peer-to-peer connection with the device. The information discovered and displayed about the wireless device 120, 200 on the user device 11-, 250 during the discovery process can influence or determine whether the connection to the wireless device through the access point 102 is maintained or whether the wireless peer-to-peer connection is used.

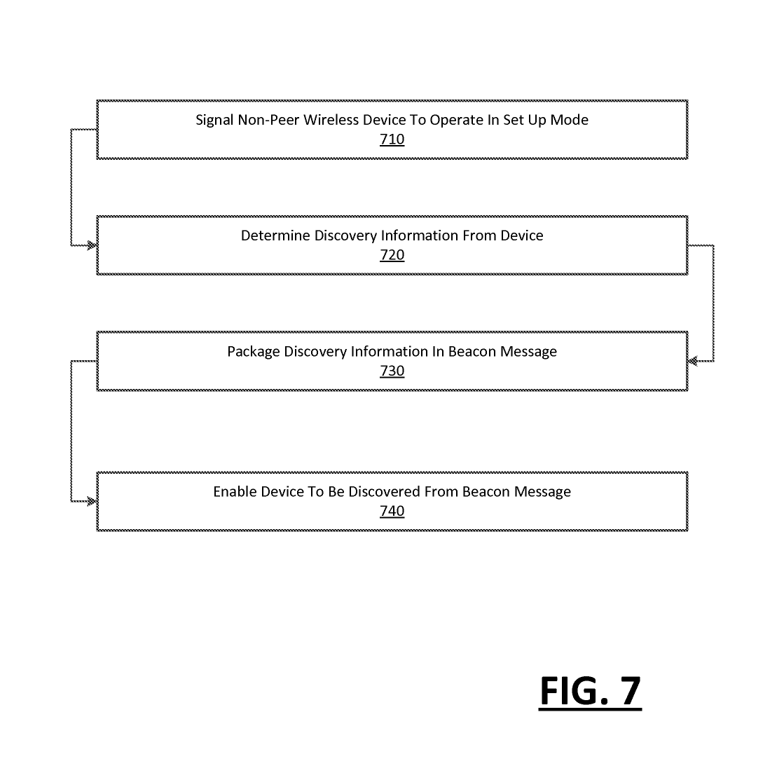

FIG. 7 illustrates a method for configuring a non-peer wireless device to implement peer-to-peer wireless communication and discovery, according to an embodiment. A non-peer wireless device includes devices which have wireless networking capability for primary purpose of connecting to a wireless access point (e.g., via Wi-Fi). Embodiments recognize that there is a large number of wireless devices that are capable of wireless connectivity to access points of the wireless network, but such devices do not inherently support a direct or peer-to-peer wireless communication protocol. Under conventional approaches, these devices are unable to provide peer connections, let alone discovery information that could be determined in the course of a peer-to-peer discovery. According to some embodiments, alternative inherent functionality of such devices is utilized for purpose of enabling Layer 2 discovery and communication.

With reference to FIG. 7, a non-peer wireless device can be signaled to operate in a setup mode (710). More specifically, embodiments recognize that non-peer wireless devices are typically operable in two modes: (i) a setup mode, when the device acts as an access point that can transmit beacon signals by which the device can then be configured for subsequent use (e.g., laptop uses the beacon to log into the device and input settings), and (ii) an operation mode, when such devices act as a wireless station which other devices access and utilize. Generally, when the setup of a non-peer wireless device is complete, the wireless device no longer operates in the set-up mode. In some embodiments, the user device 110 (e.g., see FIG. 1A) operates to instruct or otherwise signal the wireless device to switch from operating in the operation mode to operating in the set up mode. In variations, the non-peer wireless device can be manually switched from operating in the station mode to operating in the setup mode.

Once the non-peer wireless device is switched to the setup mode, the non-peer device can obtain discovery information (720). Such information can be obtained from, for example, the computer accessing and writing instructions (e.g., monitoring processes) and/or information to the non-peer wireless device while the devices in the set up mode.

The non-peer wireless device can then package discovery information in a beacon message (730). Many conventional non-peer wireless devices use beacon messages during the setup mode in order to enable other devices to access and establish connections with that device. Thus, a typical inherent capability of non-peer wireless devices is to utilize beacon messages during a setup mode. According to some embodiments, the functionality of the non-peer wireless device to provide the beacon message is repurposed in order to communicate discovery information to other devices that are accessible over a wireless communication medium (e.g., user device 110, 250). Thus, for example, the non-peer wireless device may transmit a repeated beacon message that carries discovery information for the particular device.

According to some embodiments, the beacon message can be communicated as a Layer 2 advertisement. In a process similar to that described with wireless peer devices, a user device can receive the beacon message during a discovery process (740). The discovery information provided with the beacon message can be used, for example, by the receiving device in order to determine whether a connection to that device should be made. In this way, a non-peer wireless device can provide the user device 110 with detailed information in advance of the user device connecting to the non-peer wireless device.

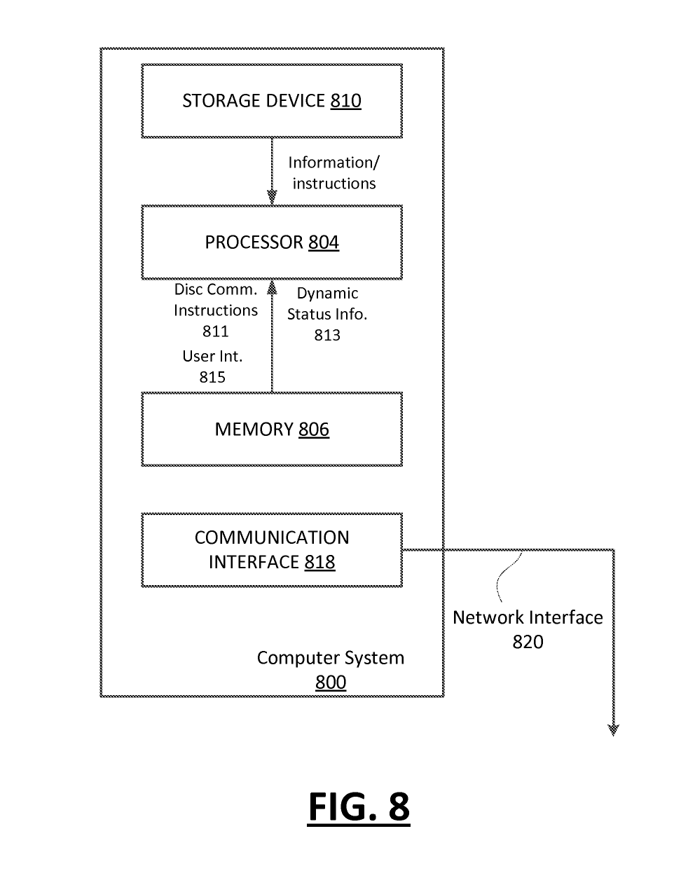

FIG. 8 is a block diagram that illustrates a computer system upon which embodiments described herein may be implemented. For example, in the context of FIG. 1A, FIG. 2A and FIG. 2B, each of the user device or wireless devices can be implemented using one or more computer systems such as described by FIG. 8.

With reference to FIGS. 1A-8, in some embodiments, computer system 800 includes processor 804, memory 806 (including non-transitory memory), storage device 810, and communication interface 818. The computer system 800 includes at least one processor 804 for processing information. The computer system 800 also includes the memory 806, such as a random access memory (RAM) or other dynamic storage device, for storing information and instructions to be executed by the processor 804. The memory 806 also may be used for storing temporary variables or other intermediate information during execution of instructions to be executed by the processor 804. The computer system 800 may also include a read only memory (ROM) or other static storage device for storing static information and instructions for the processor 804. The storage device 810, such as a magnetic disk or optical disk, is provided for storing information and instructions. The communication interface 818 may enable the computer system 800 to communicate with one or more networks through use of a network link 820 (wireless or wireline).

In some embodiments, the memory 806 may store instructions for implementing functionality (e.g., as described with an example system of FIG. 1A or FIG. 1B), computing devices (e.g., as described with examples of FIG. 2A and FIG. 2B), or methods (e.g., as described with examples FIGS. 3A-3C, 6 and 7). Likewise, the processor 804 may execute the instructions in providing functionality (e.g., as described with an example system of FIG. 1), devices (e.g., as described with examples of FIG. 2A and FIG. 2B), or methods (e.g., as described with examples FIGS. 3A-3C, 6 and 7.). In particular, when implemented as a wireless device 120, 122, 124, 126, 200, (e.g., wireless speaker) the processor 804 and memory 806 can combine to store and execute instructions 811 for generating discovery communications (“discovery communication instructions 811”) with dynamic status information 813 about an active process on the computing system 800. When implemented as the user device 110, 250, the processor 804 and memory 806 can combine to store and execute instructions 815 (“UI instructions 815) for generating the user interface 400 for rendering content based on the discovery communications.

Embodiments described herein are related to the use of computer system 800 for implementing the techniques described herein. According to some embodiments, those techniques are performed by the computer system 800 in response to the processor 804 executing one or more sequences of one or more instructions contained in the memory 806. Such instructions may be read into the memory 806 from another machine-readable medium, such as the storage device 810. Execution of the sequences of instructions contained in the memory 806 causes the processor 804 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

1. A method for operating a user device for discovering other wireless devices, the method being implemented by one or more processors of a receiving device and comprising:
receiving one or more discovery communications over a wireless communication medium, the one or more discovery communications being received using a Layer 2 protocol;
determining information included with the one or more discovery communications, the information including an identifier of a wireless device and dynamic information about an active process of the wireless device; and
displaying a representation of the wireless device without connecting to the wireless device, the representation including information determined from the one or more discovery communications, the information including the identifier of the wireless device and content that is based on the dynamic information.

2. The method of claim 1, further comprising:
responsive to user input, connecting to the wireless device using a Layer 3 protocol; and
when connected to the wireless device, updating the representation of the wireless device to include one or more control features for controlling the wireless device using the Layer 3 protocol.

3. The method of claim 2, wherein responsive to user input for a first control feature of the one or more control features, signaling a corresponding command to the wireless device.

4. The method of claim 3, wherein the first control feature is to control the active process of the wireless device, and wherein signaling the corresponding command includes signaling the command to control the active process.

5. The method of claim 4, wherein the active process includes a media player, and wherein signaling the corresponding command includes interfacing with the media player to control the media player in accordance with the corresponding command.

6. The method of claim 3, wherein the first control feature is to control a system interface of the wireless device, and wherein signaling the corresponding command includes signaling the system interface to control an aspect of a system of the wireless device.

7. The method of claim 2, wherein displaying the representation of the wireless device and updating the representation of the wireless device includes:
connecting to a second set of devices, other than the wireless device; and
when not connected to the wireless device, providing a user interface that includes a representation of (i) the wireless device, and (ii) each of the devices in the second set of devices.

8. The method of claim 7, further comprising graphically indicating a connection status of each of (i) the wireless device and (ii) each of the devices in the second set of devices.

9. The method of claim 1, further comprising, when not connected to the wireless device:
continuously or repeatedly receiving the one or more discovery communications;
processing the discovery advertisement to determine dynamic information that is current; and
updating the content based on the dynamic information that is current.

10. The method of claim 1, wherein the wireless device includes a speaker and the active process corresponds to a media player, and wherein determining information includes receiving dynamic status information about a current state of the media player.

11. The method of claim 1, wherein the wireless device is a non-peer device, and wherein the method further comprises:
wherein receiving the one or more discovery communications includes:
communicating with the non-peer device when the non-peer device is operating a set-up mode, wherein in the set-up mode, the non-peer device acts as an access point; and
receiving a beacon signal communicated from the non-peer device.

12. The method of claim 11, wherein receiving the beacon signal includes receiving vendor-specific information elements provided in the beacon.

13. A non-transitory computer-readable medium that stores instructions, which when executed by one or more processors, cause a computer system of the one or more processors to perform operations that include:
receive one or more discovery communications over a wireless communication medium, the one or more discovery communications being received using a Layer 2 protocol;
determine information included with the one or more discovery communications, the information including an identifier of a wireless device and dynamic information about an active process of the wireless device; and
display a representation of the wireless device without connecting to the wireless device, the representation including information determined from the one or more discovery communications, the information including the identifier of the wireless device and content that is based on the dynamic information.

14. The non-transitory computer-readable medium of claim 13, further comprising instructions which, when executed by one or more processors, cause the computer system to perform operations that include:
responsive to user input, connect to the wireless device using a Layer 3 protocol; and
when connected to the wireless device, update the representation of the wireless device to include one or more control features for controlling the wireless device using the Layer 3 protocol.

15. The non-transitory computer-readable medium of claim 13, further comprising instructions which, when executed by one or more processors, cause the computer system to perform operations that include: responsive to user input for a first control feature of the one or more control features, signal a corresponding command to the wireless device.

16. The non-transitory computer-readable medium of claim 15, wherein the first control feature is to control the active process of the wireless device, and wherein signaling the corresponding command includes signaling the command to control the active process.

17. The non-transitory computer-readable medium of claim 16, wherein the active process includes a media player, and wherein signaling the corresponding command includes interfacing with the media player to control the media player in accordance with the corresponding command.

18. The non-transitory computer-readable medium of claim 15, wherein the first control feature is to control a system interface of the wireless device, and wherein signaling the corresponding command includes signaling the system interface to control an aspect of a system of the wireless device.

19. The non-transitory computer-readable medium of claim 13, wherein displaying the representation of the wireless device and updating the representation of the wireless device includes:
connecting to a second set of devices, other than the wireless device; and
when not connected to the wireless device, providing a user interface that includes a representation of (i) the wireless device, and (ii) each of the devices in the second set of devices.

20. The non-transitory computer-readable medium of claim 19, further comprising instructions which, when executed by one or more processors, cause the computer system to perform operations that include, graphically indicating a connection status of each of (i) the wireless device and (ii) each of the devices in the second set.

21. The non-transitory computer-readable medium of claim 13, further comprising instructions, which when executed by one or more processors, cause the computer system to perform operations that include, when not connected to the wireless device:
continuously or repeatedly receiving the one or more discovery communications;
processing the discovery advertisement to determine dynamic information that is current; and
updating the content based on the dynamic information that is current.

22. The non-transitory computer-readable medium of claim 13, wherein the wireless device includes a speaker and the active process corresponds to a media player, and wherein determining information includes receiving dynamic status information about a current state of the media player.

23. The non-transitory computer-readable medium of claim 13, wherein the wireless device is a non-peer device, and receiving the one or more discovery communications includes:
communicating with the non-peer device when the non-peer device is operating a set-up mode, wherein in the set-up mode, the non-peer device acts as an access point; and
receiving a beacon signal communicated from the non-peer device.

24. The non-transitory computer-readable medium of claim 23, wherein receiving the beacon signal includes receiving vendor-specific information elements provided in the beacon.

25. A computing device comprising:
one or more processors;
a memory that stores a set of instructions;
a display;
a wireless communication interface;
wherein the one or more processors access the instructions stored in the memory to:
receive, using the wireless communication interface, one or more discovery communications over a wireless communication medium, the one or more discovery communications being received using a Layer 2 protocol;
determine information included with the one or more discovery communications, the information including an identifier of a wireless device and dynamic information about an active process of the wireless device; and
when not connected to the wireless device, provide, on the display, a representation of the wireless device, the representation including information determined from the one or more discovery communications, the information including the identifier of the wireless device and content that is based on the dynamic information;
responsive to user input, connect to the wireless device using a Layer 3 protocol; and
when connected to the wireless device, update the representation of the wireless device to include one or more control features for controlling the wireless device using the Layer 3 protocol.

26. The computing device of claim 25, wherein the one or more processors are responsive to user input for a first control feature of the one or more control features by signaling a corresponding command to the wireless device.

27. The computing device of claim 26, wherein the first control feature is to control the active process of the wireless device, and wherein one or more processors signal the corresponding command by signaling to control the active process.

28. The computing device of claim 26, wherein the active process includes a media player, and wherein the one or more processors signal the corresponding command by interfacing with the media player to control the media player in accordance with the corresponding command.

29. The computing device of claim 26, wherein the first control feature is to control a system interface of the wireless device, and wherein the one or more processors signal the corresponding command by signaling the system interface to control an aspect of a system of the wireless device.

30. A computing system comprising:
means for receiving one or more discovery communications over a wireless communication medium, the one or more discovery communications being received using a Layer 2 protocol;
means for determining information included with the one or more discovery communications, the information including an identifier of a wireless device and dynamic information about an active process of the wireless device; and
means for displaying, a representation of the wireless device when not connected to the wireless device, the representation including information determined from the one or more discovery communications, the information including the identifier of the wireless device and content that is based on the dynamic information;
means for connecting to the wireless device using a Layer 3 protocol; and
means for updating the representation of the wireless device, when connected to the wireless device, to include one or more control features for controlling the wireless device using the Layer 3 protocol.
